(19) United States
(12) Patent Application Publication
(10) Pub. No.: US 2011/0185279 A1
(43) Pub. Date: Jul. 28, 2011

(54) METHODS AND SYSTEMS FOR REQUESTING AND DELIVERING MELODY MESSAGES

(76) Inventor: Stephen Ingkavet, Brooklyn, NY (US)

(21) Appl. No.: 13/012,553

(22) Filed: Jan. 24, 2011

Related U.S. Application Data
(60) Provisional application No. 61/297,668, filed on Jan. 22, 2010.

(51) Int. Cl. G06F 3/16; G06F 3/048

(52) U.S. Cl. 715/727; 715/780

(57) ABSTRACT

A method for requesting and creating a personalized message by selecting a song clip, entering a recipient's phone number, and recording a personalized message, which is then sent to the identified recipient at a scheduled date and time by phone. The personalized message can be received by a recipient who answers the phone, or can be recorded by the recipient's voicemail system.

### CROSS-REFERENCE TO RELATED APPLICATION

This application claims the benefit of U.S. Provisional Application No. 61/297,668, which was filed on Jan. 22, 2010 and is incorporated herein by reference in its entirety.

### FIELD

This invention relates generally to the field of musical recordings, and more particularly, to a method and system for requesting and delivering song and audio-recorded messages to identified recipients via an identified phone number.

### BACKGROUND

Music is one of the most powerful means of expressing emotion. Throughout history, emotions have been expressed musically through serenades, lullabies, spiritual/inspiration songs and hymns, DJ song-dedications, mix tapes, Christmas caroling of holiday songs, singing “Happy Birthday” at birthday parties/celebrations, table-side mariachi performances, wedding singers, and the writing of love songs. Greeting cards are another form of communicating love and affection. In the United States alone, the greeting card industry averages about $7-7.5 billion a year in sales. An estimated 90% of households in the United States purchase an average of 30 greeting cards a year. Additionally, it is estimated that 9 out of 10 Americans look forward to receiving personal letters or greeting cards from friends and family, helping to maintain relationships and bonds with loved ones.

The use of mobile phones has increased dramatically over the years. There are over 276.6 million wireless subscribers in the United States, with an estimated 89% of American households using mobile phones. Of this population, it is estimated that about 20% are wireless-only households. Further, with an increase in mobile phone usage, it is estimated that there are 1.36 trillion SMS (text) messages sent annually. It is estimated that 60% of the world's population uses mobile phones to communicate.

Although current methods of providing greetings via a mobile phone, such as texts, are great for maintaining contact with other people, these methods do not allow for a high level of personalization and, as a result, can appear impersonal or lacking as compared to greeting cards or other more personal modes of expression.

Accordingly, it is desirable to provide methods and systems that provide the immediacy and functionality of mobile phone messages, but maintain the personalized impact of receiving a greeting card or the like.

### SUMMARY

In one embodiment, a system and method is provided for communicating with others using the massive emotional power of music delivered via a mobile or other phone service with a personalized message.

In a specific embodiment, a method of providing a messaging system for selection and delivery of a personalized message to be sent to an identified recipient is provided. The method comprises providing an interface for the creation of a user profile; registering the user profile by associating the user profile with a user; providing a searchable song clip database to the user; directing the user to select a song clip from the searchable song clip database to create a personalized message for an intended recipient; directing the user to enter a phone number of the intended recipient; directing the user to schedule a date and time that the personalized message is to be delivered to the recipient; providing the recipient with a unique message code that is associated with the personalized message; and delivering the personalized message to the intended recipient.

In specific implementations, the searchable song clip database can be searched by song title, identified occasion, or identified genre. In other specific implementations, the method can comprise the act of directing the user to record an additional sound recording and the additional sound recording can be appended to the personalized message. The additional sound recording can be a voice recording prepared by the user and/or any other audio file that can be uploaded otherwise delivered to the system by the user. In addition, before the personalized message is delivered to the intended recipient, the intended recipient can be prompted to enter the user's unique message code into the messaging system.

The foregoing and other objects, features, and advantages of the embodiments of the present disclosure will become more apparent from the following detailed description, which proceeds with reference to the accompanying figures.

### BRIEF DESCRIPTION OF THE DRAWINGS

FIG. 1 shows a screenshot of a user interface in which an online website comprises an initial log-on screen.

FIG. 2 shows a screenshot of a music and/or sound clip search engine, from which users are able to search for a desired song or sound clip by occasion and genre.

FIG. 3 shows a screenshot of a set-up menu, which can be configured to prompt a user to enter a phone number of an intended recipient.

FIG. 4 shows a screenshot of a confirmation page, which allows the user to review their selections.

### DETAILED DESCRIPTION

The following description is exemplary in nature and is not intended to limit the scope, applicability, or configuration of the invention in any way. Various changes to the described embodiment may be made in the function and arrangement of the elements described herein without departing from the scope of the invention.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

Described herein is a novel method and system for users to request and send song clips and audio greetings to identified recipients. The novel method and system is described below.

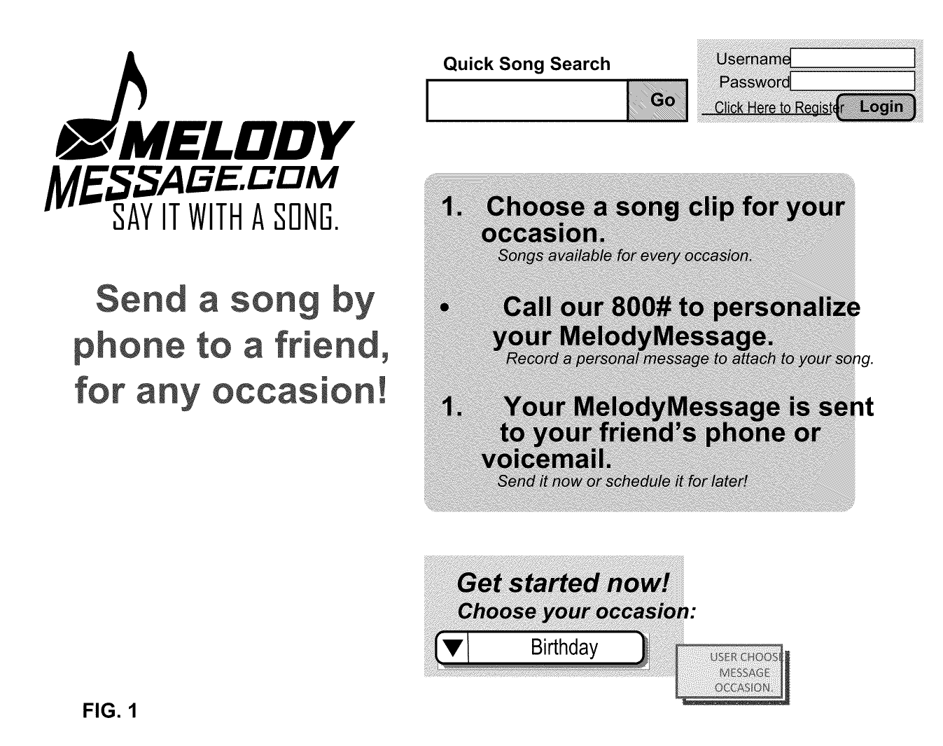

FIG. 1 shows a screenshot of an online website's initial log-on screen. From the initial log-on screen, returning users can log into their account, and new users can register for a new account. Additionally, from the initial log-on screen, users are briefly instructed on how to create a personalized message and are encouraged to begin creating a personalized message.

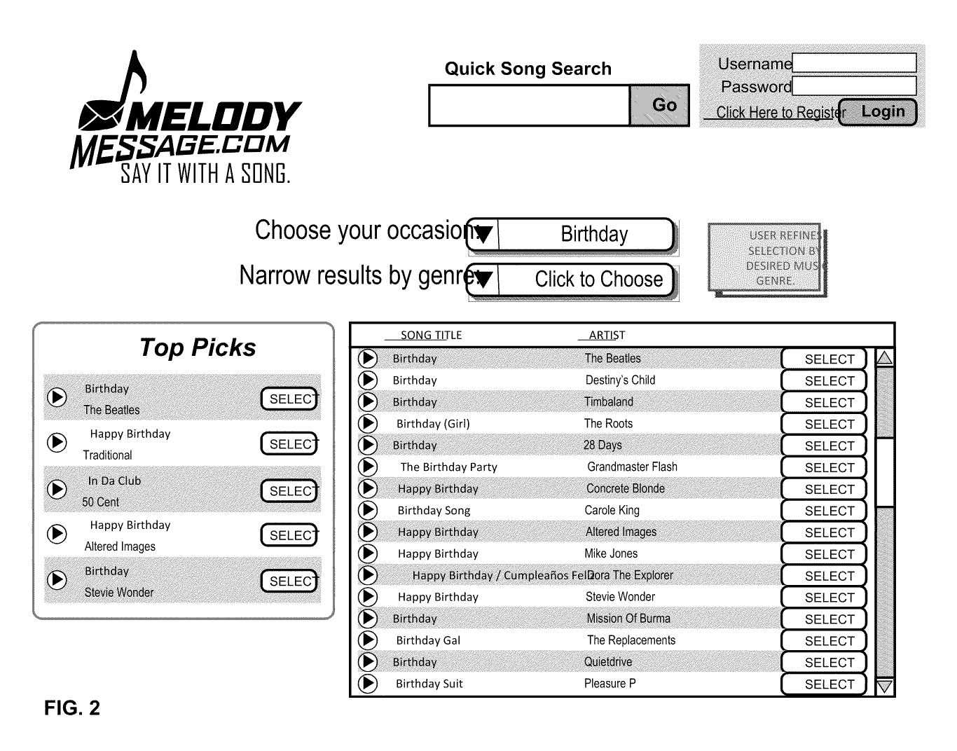

FIG. 2 shows a screenshot of a search engine from which users are able to search for a desired song clip organized in a drop-down menu by occasion and in a second drop-down menu organized by genre. The song clips are displayed by song title and artist in a menu, which allows the user to select the desired song clip to add to their personalized message.

Additionally, users are given the ability to do a quick song search for a specific song clip, by entering the song title in the “quick song search” specified search engine. Song clips that are identified by the search engine are displayed by song title and artist in a menu, which allows the user to select the desired song clip to add to their personalized message.

Also, the top song clip picks for the user-specified occasion are shown in a separate box, to assist the user in picking a song clip to add to their personalized message, as shown in FIG. 2.

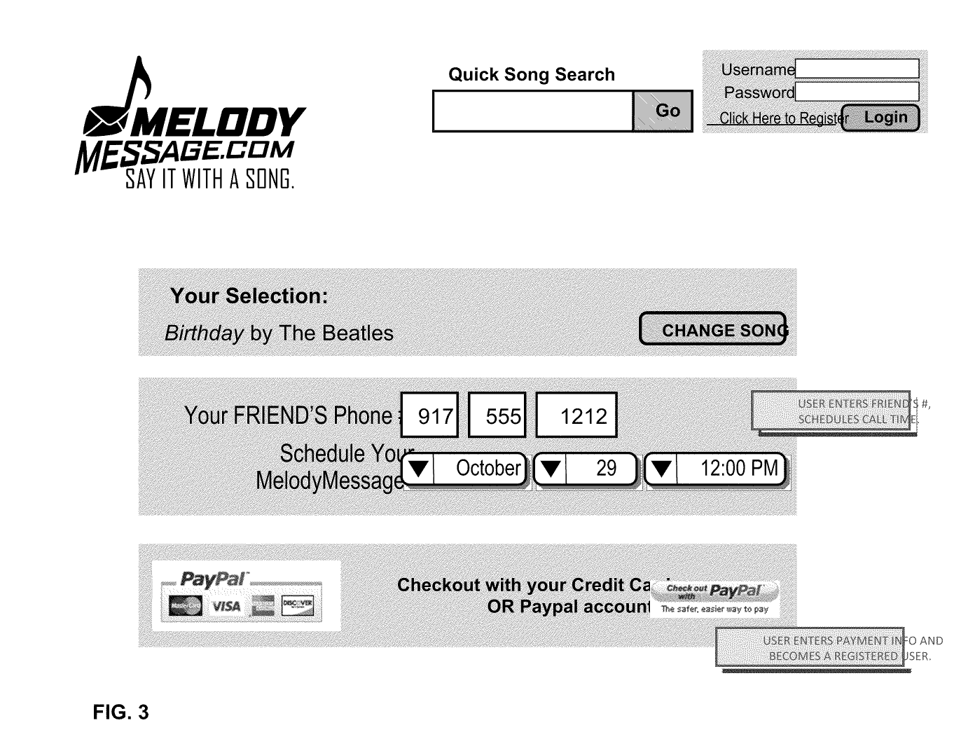

FIG. 3 shows a screenshot of the systems set-up menu. The set-up menu prompts users to enter the recipient's phone number. Additionally, the user is prompted to schedule the delivery time of the personalized message. This allows the user to pre-order a personalized message, and delay the delivery of the personalized message to a specific date and time of the user's choosing. Lastly, the screenshot shows the payment options available to the user, for example, either via credit card or PAYPAL™.

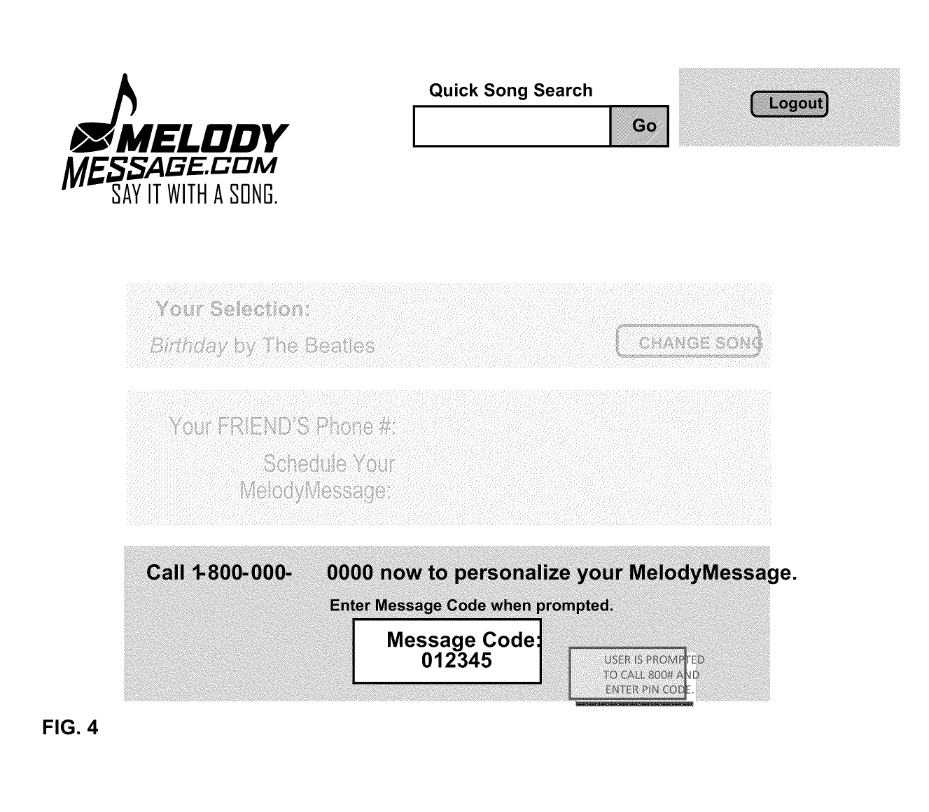

FIG. 4 shows a screenshot of a confirmation page. The confirmation page can allow the user to review their selected personalized message. The confirmation page identifies the selected song clip, and allows the user to change the selected song clip if desired. Additionally, the confirmation page identifies the recipient's phone number, and the scheduled date and time for delivery of the personalized message. Lastly, the user can be prompted to append a recorded message or other audio file. For example, the user can be given a message code, or PIN code, and prompted to call a telephone number (e.g., a 1-800 telephone number) to add an audio recording to their personalized message.

### Example 1

### User Creates a Melody Message

a. User logs-on to the Melody Message website.
b. User searches for a song-clip by genre, occasion, or by entering a specific song title.
c. User selects desired song-clip from displayed list.
d. User enters in the recipient's phone number.
e. User selects the desired delivery day and time, by use of drop-down menus.
f. User pays for the Melody Message by selecting their desired form of payment and completing the necessary payment steps (i.e. entering in credit card information or identifying their PAY PAL™ account).
g. User is shown a confirmation page, identifying the selected song clip, recipient's phone number, and the scheduled delivery date and time of the Melody Message.
h. User is given a unique message code (i.e. PIN code), which is used to add a personal audio recording to their Melody Message.
i. User calls the 1-800 number, and follows the voice prompts to record a personal audio recording, which is then appended to the song clip.

### Example 2

### User Records a Personal Audio Recording

a. After creating a Melody Message, user calls the 1-800 Melody Message number, and follows the voice-prompts to record a personal audio recording.
b. Announcer instructs user to enter the unique message code (i.e. PIN code) provided by the Melody Message website.
c. User enters in the unique message code (i.e. PIN code) provided by the Melody Message website.
d. Announcer informs the user “Your Melody Message is almost ready. Just leave your 30-second personalized message at the tone, and hang up when you're done. Your Melody Message will be on its way.”
e. At the sound of a “beep,” the user records a personalized message of up to 30-seconds.
f. Once the user is finished recording a personalized message, the user ends the phone call, and the Melody Message is complete.

### Example 3

### Recipient Receives a Melody Message

a. Recipient's phone rings.
b. Recipient answers the phone, or a voicemail system answers the phone.
c. Announcer states: “Hi, you've got a Melody Message from a friend!”
d. The song clip selected by the sender is played.
e. The sender's pre-recorded audio message is played at the end of the song clip.
f. At the end of the message, the Announcer encourages the recipient to send a Melody Message to another recipient.

The methods and systems can be performed using various systems. For example, Examples 1-3 illustrate one exemplary embodiment where the method includes steps that can be performed on any telecommunications network, such as, for example, a public switched telephone networks (PSTN), a wireless network, or a voice over internet protocol system. In other words, the user can call a number using one of these networks to record a message for delivery.

In other embodiments, it should be understood that the methods and systems can be performed using software that can be used on any system or device that can run the software such as, for example, a mobile device (e.g., a smartphone, tablet, PDA, etc.) or a personal computer. In addition, in some embodiments, the software can be configured to run within a social network such as Facebook™, MySpace™, or any other such social network service and/or website. In some embodiments, the recorded message can be directly recorded by the mobile device and/or computer and then appended and/or included with the message for delivery to the recipient. If the recording of the personal message is performed using software on a mobile device or personal computer, the step of calling a phone number to record a message can be omitted. Instead, the message can be recorded directly by the mobile device or personal computer, and the recorded message can then be transferred (e.g., uploaded to a website, server, etc.) to be appended and/or included with the selected message prior to delivery of the personalized message.

As described above, in some embodiments, a message creation code can be provided, which the user can enter prior to recording the personal message. In other embodiments, a message retrieval code can be additionally or alternatively provided. Instead of sending the personalized recording directly to the intended recipient, for example, the intended recipient can receive a link or phone number from which they are prompted to enter the message retrieval code before accessing the personalized message intended for them.

Implementations of Methods and Systems Using Software

Thus, the methods described herein can be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems, such as a mobile device, tablet, laptop, or other personal computing system. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device.

Such software can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor.

Furthermore, any of the software embodiments (comprising, for example, computer-executable instructions for causing a computer to perform any of the disclosed methods) can be transmitted, received, or accessed through a suitable communication means. Similarly, any data structure, data file, intermediate result, or final result created or modified using any of the disclosed methods can be transmitted, received, or accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means now known or unknown. Moreover, any data structure, data file, intermediate result, or final result produced by any of the disclosed methods can be displayed to a user using a suitable display device (e.g., a computer monitor or display). Such displaying can be performed as part of a computer-implemented method of performing any of the disclosed methods.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A method of providing an messaging system for selection and delivery of a personalized message to be sent to an intended recipient, the method comprising:
providing an interface for the creation of a user profile;
registering the user profile by associating the user profile with a user;
providing a searchable song clip database to the user;
directing the user to select a song clip from the searchable song clip database to create a personalized message for an intended recipient;
directing the user to enter a phone number of the intended recipient;
directing the user to schedule a date and time that the personalized message is to be delivered to the recipient;
providing the recipient with a unique message code that is associated with the personalized message; and
delivering the personalized message to the intended recipient.

2. The method of claim 1, wherein the searchable song clip database can be searched by song title, identified occasion, or identified genre.

3. The method of claim 1, further comprising the act of directing the user to record an additional sound recording and appending the additional sound recording to the personalized message.

4. The method of claim 3, wherein the additional sound recording is a voice recording of the user.

5. The method of claim 1, wherein before the personalized message is delivered to the intended recipient, the intended recipient is prompted to enter the user's unique message code into the messaging system.

6. A computer-readable storage medium storing computer-executable instructions for causing a computer to perform a method of providing a personalized message to an intended recipient, the method comprising:
providing a searchable song clip database to the user;
directing the user to select a song clip from the searchable song clip database to create a personalized message for an intended recipient;
directing the user to enter a phone number, screen name, or other identifier designating contact information for the intended recipient;
directing the user to schedule a date and time that the personalized message is to be delivered to the recipient; and
delivering the personalized message to the intended recipient at the identifier that designates contact information of the intended recipient.

7. The method of claim 6, further comprising:
providing an interface for the creation of a user profile;
registering the user profile by associating the user profile with a user; and
providing the user with a unique message code that is associated with the personalized message, the unique message code being configured to allow the user to record the personalized message.

8. The method of claim 6, wherein the method is performed using an application on a mobile phone.

9. The method of claim 6, wherein the method is performed using an application within a social networking service.

10. The method of claim 6, wherein the searchable song clip database can be searched by song title, identified occasion, or identified genre.

11. The method of claim 6, further comprising the act of directing the user to record an additional sound recording and appending the additional sound recording to the personalized message.

12. The method of claim 11, wherein the additional sound recording is a voice recording of the user.

13. The method of claim 6, further comprising:
prompting the intended recipient to enter a message retrieval code into the messaging system to obtain access to the personalized message.
